(19) United States
(12) Patent Application Publication
(10) Pub. No.: US 2012/0251085 A1
(43) Pub. Date: Oct. 4, 2012

(54) VIDEO MULTIPLEXING

(76) Inventors: Hown Cheng, Cupertino, CA (US); Do Hwan Lim, San Jose, CA (US); Heejeong Ryu, Cupertino, CA (US)

(21) Appl. No.: 13/222,105

(22) Filed: Aug. 31, 2011

Related U.S. Application Data
(60) Provisional application No. 61/470,194, filed on Mar. 31, 2011.

(51) Int. Cl. H04N 5/91

(52) U.S. Cl. 386/337; 386/E05.003

(57) ABSTRACT

A video system including a plurality of video sources, a recording device, a memory, and a controller. The controller receives video frames from the video sources and includes a first and a second write control module, a read control module, and a frame rate control module. The first write control module includes a write pointer and writes a first video frame to a first frame buffer. The second write control module includes a second write pointer and writes a second video frame to a second frame buffer. The read control module includes a read pointer. The frame rate control module controls the reading of the first and second video frames based on a multiplexing order and a read memory location of the read pointer respecting a write memory location of the write pointer. The read control module outputs a multiplexed signal to the recording device according to the multiplexing order.

### RELATED APPLICATIONS

This application claims the benefit of prior-filed, co-pending U.S. Provisional Patent Application No. 61/470,194, filed Mar. 31, 2011, the entire content of which is hereby incorporated by reference. This application is also related to U.S. patent application Ser. No. ______ (Attorney Docket No. 022490-9009-01), filed on the same date herewith.

### BRIEF DESCRIPTION OF THE DRAWINGS

FIG. 1 illustrates a video system according to an embodiment of the invention.

FIG. 2 is a frame synchronization diagram according to an embodiment of the invention.

FIG. 3 illustrates a video recording system according to an embodiment of the invention.

FIG. 4 illustrates a plurality of input channels and a corresponding plurality of video frames according to an embodiment of the invention.

FIG. 5 illustrates a multiplexed output signal according to an embodiment of the invention.

FIG. 6 illustrates a controller associated with the video system of FIG. 1 according to an embodiment of the invention.

FIG. 7 is a timing diagram for a time-domain multiplexed 4D1 video output according to an embodiment of the invention.

FIG. 8 illustrates a 4-D1 video output according to an embodiment of the invention.

FIG. 9 illustrates a 4D1 video output according to an embodiment of the invention.

FIG. 10 illustrates a 6VGA video output according to an embodiment of the invention.

FIG. 11 is a process for video multiplexing according to an embodiment of the invention.

FIG. 12 illustrates a remote processing and storage device according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention described herein provide a video multiplexing and recording system that is capable of recording video input signals received from a plurality of input channels (e.g., 16 input channels, etc.) without regard for whether the video input signals have the same frame rate, are synchronized, are corrupted, are incorrect, etc. This is achieved, in part, using individual input channel synchronization, as described herein. In one embodiment, a video system is provided that includes a plurality of video sources, a controller, a memory, and a recording device. The memory includes a plurality of frame buffers. The controller is configured to receive a plurality of video input signals from the plurality of video sources. The controller includes, among other things, one or more write control modules, one or more frame rate control modules, and one or more read control modules. The one or more frame rate control modules are configured to control the writing of video frames to the plurality of frame buffers, as well as control the reading of the video frames from the plurality of frame buffers. Frame-level synchronization by the one or more frame rate control modules among the writing operations, reading operations, and multiplexing operations ensures that, for example, a frame that is being written to a buffer is not simultaneously trying to be read from the buffer. Additionally, the one or more frame rate control modules ensure that the video frames are read from the frame buffers in a sequence such that the video frames are correctly multiplexed and recorded.

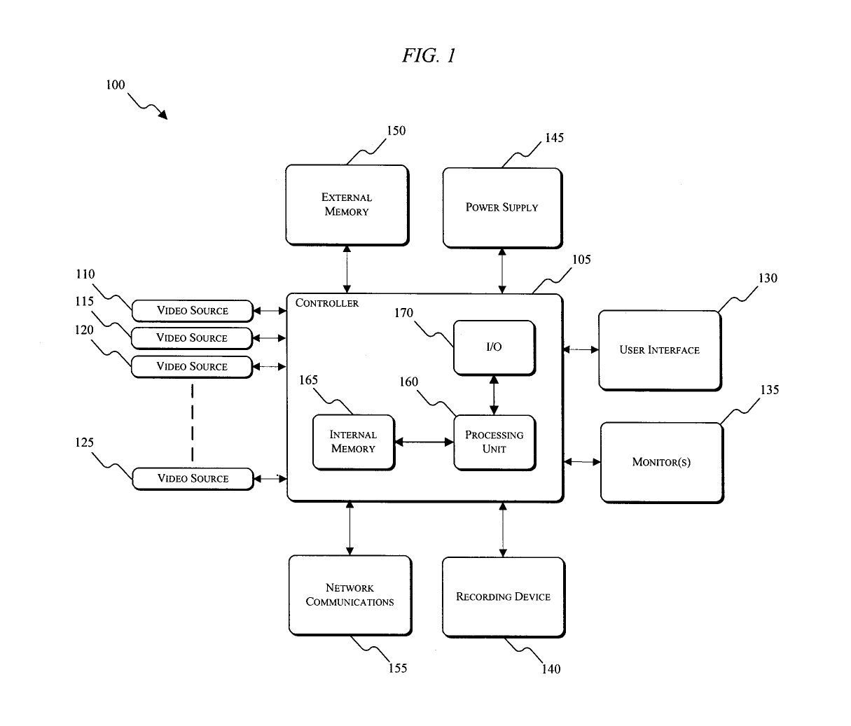

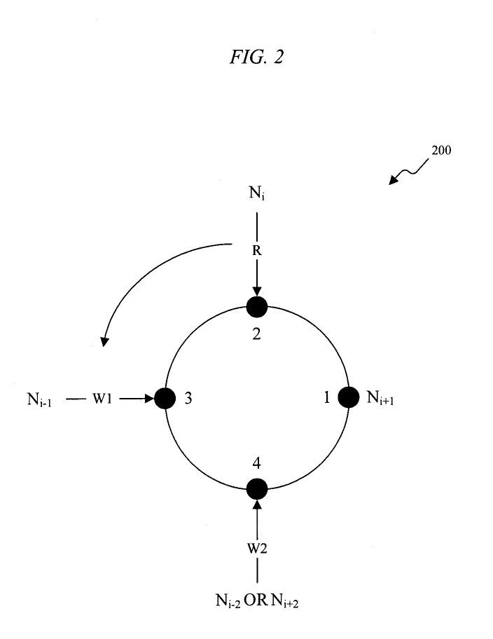

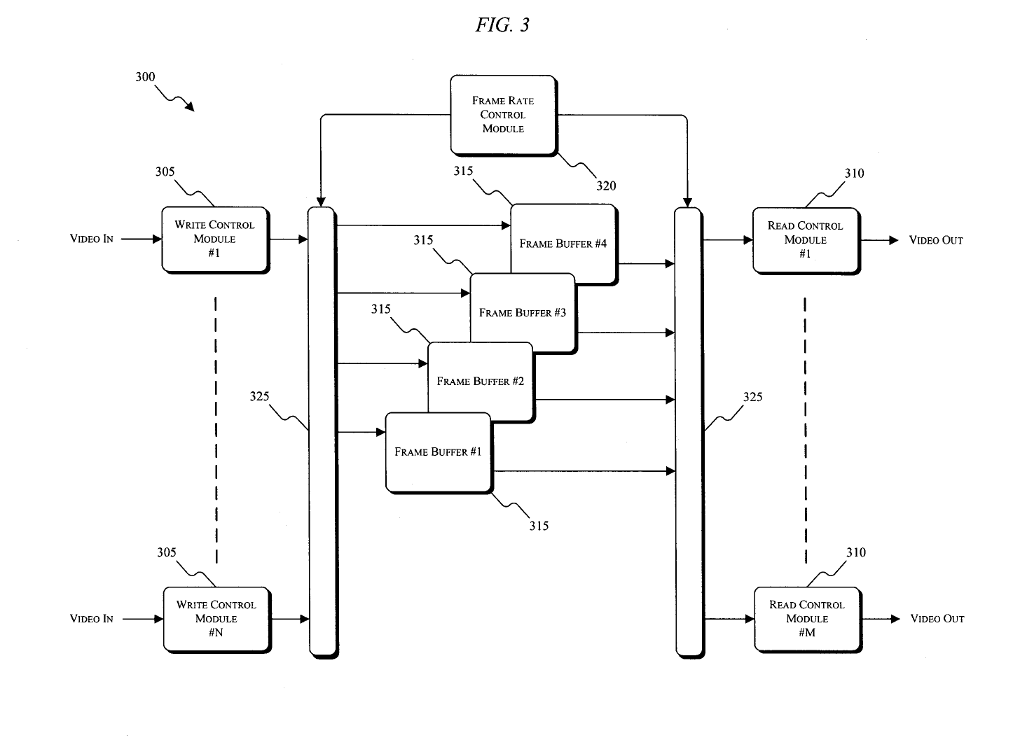

FIG. 1 illustrates a video system 100 (e.g., for security applications, multi-channel digital video recorder [“DVR”] applications, etc.) that includes a controller 105 and a plurality of video sources 110-125 corresponding to a plurality of input channels. The controller 105 is electrically and/or communicatively connected to the video sources 110-125, as well as a variety of additional modules or components of the video system 100. For example, the illustrated controller 105 is connected to a user interface module 130, one or more monitors 135, a recording device 140, a power supply module 145, one or more external memory modules 150, and a network communications module 155. The controller 105 includes combinations of software and hardware that are operable to, among other things, receive and process video input signals, control information and data provided to the user interface module 130 or the one or more monitors 135, etc. In some constructions, the controller 105 includes a plurality of electrical and electronic components that provide power, operational control, and protection to the components and modules within the controller and/or video system. For example, the controller 105 includes, among other things, a processing unit 160 (e.g., a microprocessor, a microcontroller, or another suitable programmable device), an internal memory 165, and an input/output (“I/O”) system 170. The controller 105 also includes one or more write control modules, one or more read control modules, and one or more frame rate control modules, as shown and described below with respect to FIGS. 2 and 3. In some constructions, the controller 105 is implemented partially or entirely on a semiconductor (e.g., a field-programmable gate array [“FPGA”] semiconductor) chip, such as a chip developed through a register transfer level (“RTL”) design process. As an illustrative example, the controller 105 can be an advanced multi-channel HD display/record/playback controller integrated circuit (“IC”).

The internal memory 165, external memory 150, and/or the recording device 140 include, for example, a read-only memory (“ROM”), a random access memory (“RAM”) (e.g., dynamic RAM [“DRAM”], synchronous DRAM [“SDRAM”], etc.), an electrically erasable programmable read-only memory (“EEPROM”), a flash memory, a hard disk, an SD card, or another suitable magnetic, optical, physical, or electronic memory device. The processing unit 160 is connected to the internal memory 165 and executes software that is capable of being stored in a RAM of the internal memory 165 (e.g., during execution), a ROM of the internal memory 165 (e.g., on a generally permanent basis), or another non-transitory computer readable medium such as another memory or a disc.

In some embodiments, the controller 105 or network communications module 155 includes one or more communications ports (e.g., Ethernet, serial advanced technology attachment [“SATA”], universal serial bus [“USB”], integrated drive electronics [“IDE”], etc.) for transmitting, retrieving, or storing video frames or information related to the video system to one or more devices external to the controller 105. Software included in the implementation of the video system 100 can be stored in the memory 165 of the controller 105. The software includes, for example, firmware, one or more applications, program data, one or more program modules, and other executable instructions. The controller 105 is configured to retrieve from memory and execute, among other things, instructions related to the control processes and methods described herein. In other constructions, the controller 105 includes additional, fewer, or different components. In some constructions, the controller 105 can be implemented as any of a variety of devices capable of receiving and processing video input signals from the plurality of video sources. For example, the controller 105 (e.g., an FPGA semiconductor chip) is used with an embedded 8/16 channel DVR, a hybrid HD DVR, an HD video multiplexer, a network video recorder, a television (e.g., a smart TV), a smart phone, a personal computer (“PC”), a tablet PC, a laptop computer, a personal digital assistant (“PDA”), or a server. Additionally or alternatively, the controller 105 is incorporated into a device that is separate from and connectable (e.g., physically, electrically, communicatively, etc.) to the devices described above.

The power supply module 145 supplies a nominal AC or DC voltage to the controller 105 or other components or modules of the video system 100. The power supply module 145 is powered by, for example, mains power having nominal line voltages between 100V and 240V AC and frequencies of approximately 50-60 Hz. The power supply module 145 is also configured to supply lower voltages to operate circuits and components within the controller 105 or video system 100. In other constructions, the controller 105 or other components and modules within the video system 100 are powered by one or more batteries or battery packs, or another grid-independent power source (e.g., a generator, a solar panel, etc.).

The user interface module 130 and the one or more monitors 135 are used to monitor the video system 100 in substantially real-time or based on recorded video. For example, the user interface module 130 and the one or more monitors 135 are operably coupled to the controller 105 to receive live or substantially real-time video feeds from the plurality of video sources 110-125, to receive recorded video feeds from the plurality of video sources 110-125 or recording device 140, etc. The user interface module 130 and the one or more monitors 135 can include a combination of digital and analog input or output devices required to achieve a desired level of control and monitoring for the video system 100. For example, the user interface module 130 and the one or more monitors 135 can each include a display (e.g., a primary display, a secondary display, etc.) and input devices such as touch-screen displays, a plurality of knobs, dials, switches, buttons, etc. The display is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or the like. The display is configured to display one or more video feeds received from the controller 105. The video feeds can correspond to any of a variety of formats or resolutions including common intermediate format (“CIF”), video graphics array (“VGA”), composite video (“CVBS”), red green blue (“RGB”), high-definition multimedia interface (“HDMI”), BT.1120 (“1080i”), D1, etc. The user interface module 130, the one or more monitors 135, the recording device 140, etc., can also be configured to display conditions or data associated with the video system in real-time or substantially real-time (e.g., as an on-screen display [“OSD”]). For example, the user interface module 130 is configured to display the status or characteristics of the video system, time stamps, etc.

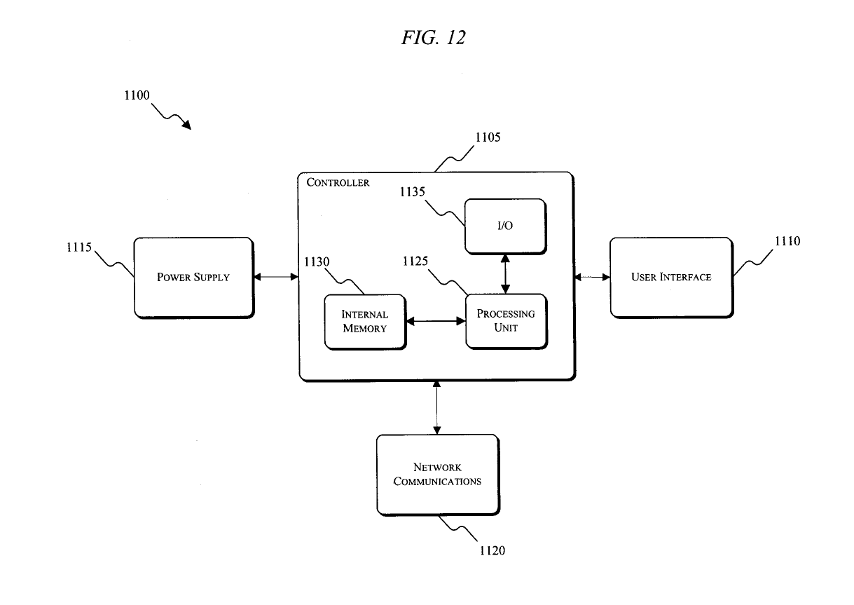

In some embodiments, the information and data (e.g., video frames) associated with the operation and status of the video system 100 are sent, transferred, or transmitted using the network communications module 155 to a remote or mobile processing and storage device 1100 (see FIG. 12) for remote monitoring, remote control, data logging, etc. The remote device is, for example, a personal computer, a laptop computer, a mobile phone, tablet computer, personal digital assistant (“PDA”), a server, a database, or the like. In some implementations, the data is transferred via a wireless local area network (“LAN”), a neighborhood area network (“NAN”), a home area network (“HAN”), or a personal area network (“PAN”) using any of a variety of communications protocols, such as Wi-Fi, Bluetooth, ZigBee, or the like. Additionally or alternatively, the data is transferred to the remote or mobile device over a wide area network (“WAN”) (e.g., a TCP/IP based network, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a Digital Enhanced Cordless Telecommunications (“DECT”) network, a Digital AMPS (“IS-136/TDMA”) network, an Integrated Digital Enhanced Network (“iDEN”), a Digital Advanced Mobile Phone System (“D-AMPS”) network, etc.).

The remote or mobile device 1100 can include, for example, a separate controller 1105, a user interface module (e.g., a display) 1110, a power supply module 1115, and a communications module 1120 which operate in a similar manner to corresponding components of the video system 100 described above. The remote device 1100 also includes combinations of hardware and software that are operable to, among other things, control the operation of the video system 100, control the information that is presented on the display, etc. For example, the controller 1105 includes a processing unit 1125 (e.g., a microprocessor, a microcontroller, or another suitable programmable device), an internal memory 1130, and an input/output (“I/O”) system 1135. The information received from the video system 100 can be received through the communications module 1120 which includes one or more antennas, one or more network interface cards (“NICs”), or the like for communicating over one or more of the networks described above.

FIG. 2 is a diagram 200 that illustrates the operation of one of the one or more frame rate control modules within the controller 105. The frame rate control module is configured for use with, for example, both read and write operations associated with the multiplexing and recording of video input signals. In some embodiments, each input channel includes a write control module having a write pointer and one or more read control modules having a read pointer (both shown and described below with respect to FIG. 3). The frame rate control module can control and monitor the locations or relative locations of the read pointer and the write pointer. The read pointer and the write pointer are used to determine which frame buffers (e.g., memory addresses or blocks of memory addresses within SDRAM) are read from (i.e., by one or more read control modules) or written to (i.e., by a write control module), respectively. The frame rate control module uses the locations of the read pointer and the write pointer to ensure that the frame that is trying to be read from a frame buffer is not also being written to the frame buffer. For example, an error or fault may occur if a read control module attempts to read a frame from a frame buffer that is concurrently being written to the frame buffer. As such, the frame rate control module controls the locations of the read pointer and the write pointer with respect to one another such that the simultaneous reading and writing of a frame does not occur. In some embodiments, the read pointer is maintained a predetermined number of frames or buffers (e.g., at least one) away from a frame that is being written to memory to prevent the read pointer and the write pointer from overlapping.

With reference to FIG. 2, a circular buffer configuration corresponding to an input channel is illustrated. In the illustrated embodiment, the circular buffer corresponds to four address locations or blocks of addresses in the memory 150 (e.g., frame buffers). These memory locations are designated by the numbers 1, 2, 3, and 4. The address locations are also given the temporal designations Nᵢ, Nᵢ₊₁, Nᵢ₋ᵢ, and Nᵢ₋₂ which signify time relationships with respect to a current read operation. The symbol ‘R’ indicates which of the address locations is being read from the memory 150, and the symbols ‘W1’ and ‘W2’ indicate address locations where video frames have been written to the memory 150. In some embodiments, the address locations indicated by ‘W1’ and ‘W2’ correspond to different input channels. When writing a video frame to the memory 150, each video frame is written to a corresponding memory location on a line-by-line basis. When the writing of the video frame is completed, a new video frame will be written based on signals received from a frame rate control module (e.g., a suggested next write pointer location). If a new video frame cannot be written, the previous video frame may be rewritten, the new video frame may be skipped, etc. At time Nᵢ, a read control module is reading a frame located at memory location 2. The frame that is read out from the memory 150 is a frame that was previously written to the memory 150. After the frame at time Nᵢ and memory location 2 has been read from memory, the frame rate control module advances the read pointer to the next frame (i.e., at time Nᵢ₋₁ and memory location 3) which was written to the memory 150 subsequent to the frame at time Nᵢ and memory location 2. Once the frame at time Nᵢ₋₁ and memory location 3 has been read from the memory 150, the frame rate control module advances the read pointer to the frame stored at time Nᵢ₋₂ and memory location 4. The frame stored at time Nᵢ₋₂ and memory location 4 was stored subsequent to the frame stored at time Nᵢ₋₁ and memory location 3. The frame rate control module continues to control which frames are read from the memory 150 such that the frame being read from the memory 150 remains at least one frame (e.g., two frames) behind the frame being written to the memory 150.

FIG. 3 is a block diagram that is illustrative of a video multiplexing and recording system 300 according to an embodiment of the invention. The system 300 includes one or more write control modules 305, one or more read control modules 310, a plurality of frame buffers 315 (e.g., in memory 150), and one or more frame rate control modules 320. The number of frame rate controllers can vary depending upon, for example, how many input channels are being multiplexed at one time. In a simplified example, one frame rate control module controls the multiplexing of four input channels. For a total of 16 input channels, four frame rate controllers would be included. Alternatively, one frame rate control module may be used to multiplex all 16 input channels. Other numbers of frame rate control modules are possible. For descriptive purposes, the write operations of the write control modules 305 and the read operations of the read control modules 310 are shown and described with respect to a single input channel (e.g., one write control module, one frame rate control module, and associated frame buffers). However, each input channel to the system 300 can correspondingly include a write control module, a frame rate control module, and associated frame buffers.

The number of read control modules associated with the system 300 is dependent upon, for example, the number of recording devices connected to the system 300. The frame rate control modules 320 are connected to the one or more write control modules 315 and the one or more read control modules 320 via control and data buses 325. The frame rate control module 320 is configured to control both write operations to the frame buffers 315 and read operations from the frame buffers 315. The write control module 305 receives a video input signal from a respective input channel regardless of whether the write control module 305 is currently writing or ready to write a video frame to one of the frame buffers 315. In some embodiments, the frame rate control module 320 provides the write control module with a suggested location for a write pointer, and the write pointer directs the write control module 305 as to which of the frame buffers 315 a video frame should be written. The suggested write pointer location is used to write the video frame to one of the frame buffers 315 unless, for example, a video frame is currently being read from the one of the frame buffers 315. In such an instance, the video frame may be discarded and the read pointer is allowed to advance before a video frame is written to the suggested write pointer location. The read control module 310 includes a read pointer, and the frame rate control module controls the location of the write pointer based on its relative location with respect to the read pointer, as described above. For example, the frame rate control module 320 monitors and controls the position of the write pointer to ensure that the write control module 305 only writes video frames to a frame buffer when the write pointer is in an appropriate position with respect to a read pointer.

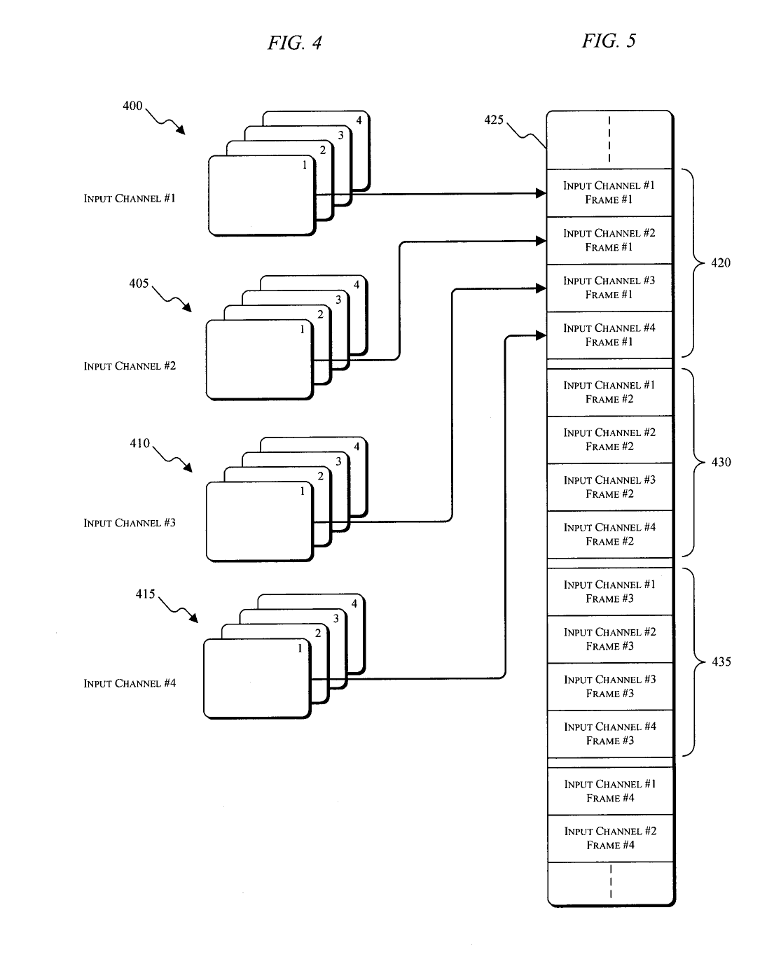

In addition to the control techniques described above, the frame rate control module 320 also controls the write pointer and the read pointer to ensure that the video input signals are properly multiplexed. When multiplexing a plurality of video input signals, the frames of each video input signal must be read from the frame buffers 315 to ensure that the multiplexed and recorded video signals are correctly reproduced on a display, as shown and described below with respect to FIGS. 4 and 5. As an illustrative example, a 4D1 multiplexed output (i.e., four 720×480 video frames combined into a single output) must have each of its four video frames at a correct position within the 4D1 output at the correct time. Continuing with the example of a 4D1 output, the read control module 310 reads video frames from the frame buffers corresponding to four different video input signals and input channels. The frame rate control module 320 controls the relative locations of the write pointers for each write control module 305 with respect to the read pointer of the read control module 310 using the relationship described above, but also controls the read pointer to ensure that the video frames written to the various frame buffers are read out in the correct sequence. After the read control module 310 has read the video frames from the frame buffers 315 in the correct sequence, the read control module 310 combines the video frames into a single output. As opposed to a conventional single D1 output having a resolution of 720×480, the 4D1 output generated by the read control module may have a resolution of, for example, 1440×960. In some embodiments, the system 300 is configured to record frames corresponding to other standard and high definition video resolutions (i.e., 1080i, etc.)

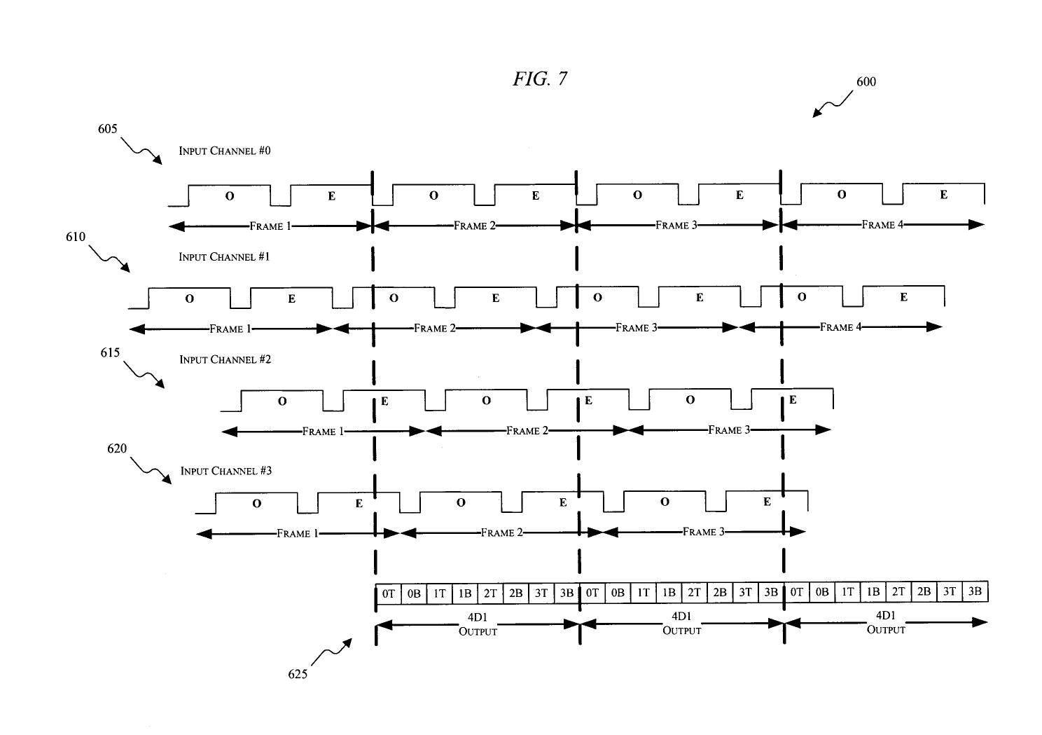

FIGS. 4 and 5 illustrate the multiplexing of the video frames in greater detail. FIG. 4 illustrates four frames 400-415 stored in respective frame buffers for each of four input channels (i.e., 1, 2, 3, and 4). Video frame #1 from each input channel is read from a buffer in ascending channel order (i.e., 1, 2, 3, 4), and combined into a first output 420 in an output data stream 425 of FIG. 5. Video frame #2 from each input channel is then read from a buffer in ascending channel order, and combined into a second output 430 in the output data stream 425, and video frame #3 from each input channel is read from a buffer in ascending channel order, and combined into a third output 435 in the output data stream 425. A similar procedure is performed for subsequent sets of video frames, different groups of input channels, etc. The use of the frame buffers, frame rate control modules, write pointers, and read pointer allow frame-level synchronization of the writing operations, reading operations, and multiplexing operations. As will be illustrated below with respect to FIG. 7, the video input signals from the input channels do not have to be synchronized with respect to one another in order to achieve a properly multiplexed set of video frames. This can be achieved because the frame rate control modules control the writing of the continuously received video frames for one input channel to the frame buffers for that input channel without regard for when the video frames of the other input channels are being received. The frame rate control modules then control the reading of the video frames by the read control modules from the frame buffers based on a desired multiplexing sequence. Similarly, video input signals having different frame rates can also be properly multiplexed. For example, the system 300 is able to output multiple video streams that each have different frame rates to a single read control module or recording device.

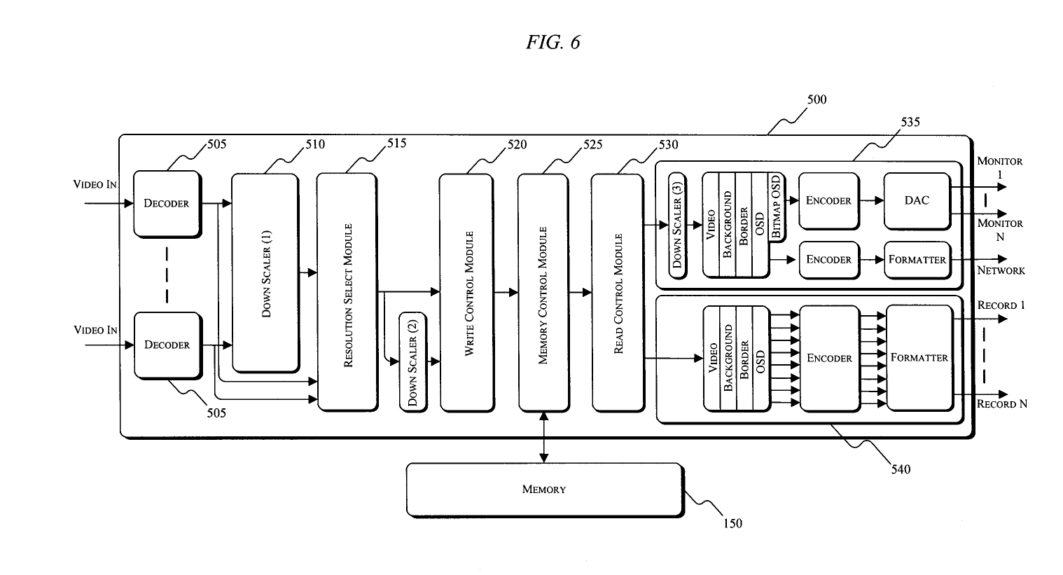

FIG. 6 illustrates a controller 500 according to one embodiment of the invention. In the illustrated embodiment, the controller 500 includes a plurality of decoders 505 (e.g., BT.656 decoders), a downscaler module 510, a resolution selection module 515, a write control module 520, a memory controller module 525, a read control module 530, a real-time output formatting module 535, and a record formatting module 540. The decoders 505 receive a plurality of video input signals from a variety of video sources (e.g., cameras, etc.). The downscaler 510 is configured to, for example, modify a resolution of a video input signal prior to recording or display, and the resolution select module 515 is configured to select, for example, a resolution at which the video input signals will be recorded (e.g., D1, VGA, etc.). In some embodiments, the plurality of decoders 505, the downscaler module 510, and the resolution selection module 515 can be included in the one or more write control modules described above with respect to FIG. 3. The write control module 520, the memory control module 525, the read control module 530 are configured to perform or execute the operations described above with respect to the write control module 305, the frame rate control module 320, and the read control module 310 of FIG. 3, respectively. In addition to the multiplexing and recording described above, the real-time output formatting module 535 and the record formatting module 540 are used to enhance the recorded or displayed video signals. The real-time output formatting module 535 and the record formatting module 540 include various encoding modules, formatting modules, digital-to-analog conversion (“DAC”) modules, on-screen display (“OSD”) modules, etc. The real-time output formatting module 535 is configured to format and enhance one or more video output signals for the one or more monitors 540 and/or corresponding to one or more network protocols (e.g., for transmission to a network device such as a server, networked computer, etc.). The record formatting module 540 is configured to format and enhance one or more video output signals for the recording device 140. The real-time formatting module 535 and the record formatting module 540 can be included in respective read control modules, monitors, or recording devices. In some embodiments, a plurality of recording devices are included in the video system, and each recording device is configured to record the same or different video output signals (e.g., two recording devices can record the same video output signal). In some embodiments, each read control module is capable of outputting data corresponding to any number of combinations of input channels (e.g., combinations of real-time video input signals and recorded video signals, etc.). The controller 500 may also be implemented partially or entirely on a semiconductor (e.g., FPGA semiconductor) chip, such as a chip developed through a register transfer level (“RTL”) design process.

FIG. 7 illustrates a timing diagram 600 according to an embodiment of the invention. The timing diagram 600 illustrates four channels 605-620 of video input signals (e.g., from four surveillance cameras). In the illustrated embodiment, the video signals are interlaced video signals, and each frame of video is represented by odd and even signals (i.e., corresponding to odd display line numbers and even display line numbers). In other embodiments, the video signals are progressive scan. The four channels of video input signals include frames that are received in an unsynchronized manner (e.g., the frames of each input channel are received in an unspecified order and at unspecified times). The video input signals are multiplexed as described above with respect to FIGS. 4 and 5 to produce a 4D1 output 625. As also described above, the order in which the frames are read from the frame buffers and multiplexed must be consistent from one 4D1 output to subsequent 4D1 outputs to ensure the proper recording and, ultimately, display of the recorded signals. In the illustrated embodiment, each 4D1 output includes a top portion and a bottom portion for each frame of each channel (i.e., 0T, 0B, 1T, 1B, 2T, 2B, 3T, and 3B), where ‘T’ designates the top portion of the frame and ‘B’ designates the bottom portion of the frame. This frame order is consistent from one 4D1 output to subsequent 4D1 outputs. In other embodiments, the bottom portion of the frame can be stored or read prior to the top portion of the frame. Additionally, although the illustrated embodiment displays only four input channels, other embodiments of the invention multiplex, for example, 8 or 16 input video channels into a single output (e.g., 8-D1 for high speed codecs).

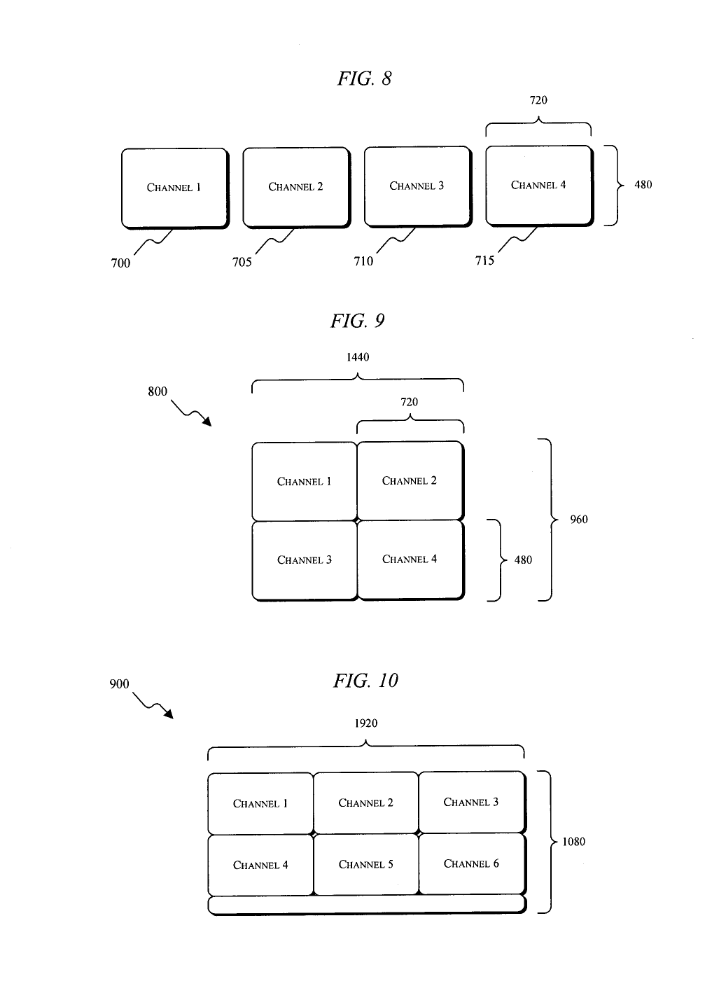

FIGS. 8-10 illustrate various outputs of the video system 100. FIG. 8 illustrates an output in which four individual D1 (i.e., 720×480) outputs 700-715 are read out serially from memory. Unlike the output shown in FIG. 8, the outputs illustrated in FIGS. 9 and 10 illustrate outputs that can be achieved using the multiplexing and recording described above. FIG. 9 illustrates an output 800 according to an embodiment of the invention in which a single recorded output that is retrieved from the recording device 140 includes four video frames from four different input channels. Unlike the serial stream of 4-D1 outputs, the multiplexed output shown in FIG. 9 is a 4D1 output that has a corresponding resolution of 1440×960. For such an output stream of data, a corresponding high speed codec allocates additional memory as needed or instructed to properly display all four video frames. Similarly, FIG. 10 illustrates a multiplexed output 900 that includes six video frames from six different input channels. In the embodiment of FIG. 10, each of the output frames are VGA (i.e., 640×480).

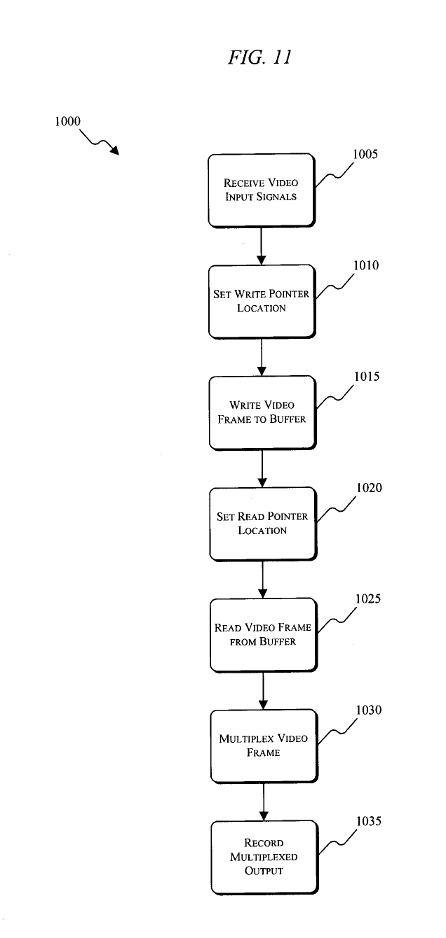

FIG. 11 is a process 1000 for multiplexing a group of video input signals into a single output data stream. Various steps described herein with respect to the process 1000 are capable of being executed simultaneously or in an order that differs from the illustrated serial manner of execution. At step 1005, video input signals associated with a plurality of input channels are received by a controller. A frame rate control module then sets a write pointer location for a write control module of the controller (step 1010). For example, the frame rate control module provides a suggested write pointer location to a write control module corresponding to a location in a memory (e.g., a frame buffer) to which a video frame will be written. The write pointer location corresponds to one of a plurality of frame buffers (e.g., four frame buffers) associated with a particular input channel. The write control module then writes the video frame to the frame buffer (step 1015). As described above, the writing operations of the write control modules are continuous for each input channel, and each input channel includes its own frame rate control module. As such, video frames are continually being written to the plurality of frame buffers associated with each of the input channels. Following step 1015, the frame rate control module sets a read pointer location for a read pointer within a read control module (step 1020). As previously described, the read pointer location is set based on, for example, a relative position of the read pointer with respect to the location of one or more of the write pointers, as well as according to a sequence for which video frames are to be multiplexed. The read control module then reads a video frame from the frame buffer corresponding to the location of the read pointer (step 1025). A similar procedure is performed to read video frames from frame buffers corresponding to different input channels. When a video frame from each of a selected group of input channels (e.g., four input channels, six input channels, etc.) have been read from frame buffers by the read control module, the read control module combines the video frames into a single multiplexed output (step 1030). The video frames are arranged within the multiplexed output according to the sequence. The read control module then outputs the multiplexed output (step 1035) to, for example, a recording device.

Thus, the invention provides, among other things, systems, methods, and computer readable media for multiplexing and recording a plurality of video input signals. Various features and advantages of the invention are set forth in the following claims.

1. A video system comprising:
a plurality of video sources corresponding to a plurality of input channels, the plurality of video sources configured to generate a plurality of video signals related to a plurality of video frames;
a recording device;
a memory including a plurality of frame buffers, the plurality of frame buffers configured to store the plurality of video frames, at least one of the frame buffers being associated with each of the plurality of video sources; and
a controller connected to the plurality of video sources, the recording device, and the memory, the controller configured to receive the plurality of video frames, the controller including
a first write control module including a first write pointer, the first write control module configured to write a first video frame to a first frame buffer,
a second write control module including a second write pointer, the second write control module configured to write a second video frame to a second frame buffer,
a read control module including a read pointer, the read control module configured to read the first video frame from the first frame buffer and the second video frame from the second frame buffer, and
a frame rate control module configured to control the reading of the first video frame and the second video frame based on a read memory location of the read pointer with respect to a write memory location of the first write pointer and the second write pointer, the frame rate control module further configured to control the reading of the first video frame from the first frame buffer and the reading of the second video frame from the second frame buffer based on a video frame multiplexing sequence,
wherein the read control module is further configured to output a multiplexed signal to the recording device including the first video frame and the second video frame arranged according to the video frame multiplexing sequence.

2. The video system of claim 1, wherein the recording device is a multi-channel digital video recorder (“DVR”).

3. The video system of claim 1, wherein the read memory location of the read pointer is maintained at least one frame behind the write memory location of the first write pointer and the second write pointer.

4. The video system of claim 3, wherein the read memory location of the read pointer is two frames behind the write memory location of the first write pointer and the second write pointer.

5. The video system of claim 1, wherein the recording device is configured to display a set of data associated with the video system as an on-screen display.

6. The video system of claim 1, wherein the read control module is further configured to serially read each of the first video frame from the first frame buffer and the second video frame from the second frame buffer to generate the multiplexed signal.

7. The video system of claim 1, further comprising a remote device configured to receive the plurality of video signals.

8. A method of multiplexing a plurality of video sources, the method comprising:
receiving a plurality of video signals including a plurality of video frames;
writing a first video frame to a first frame buffer based on a write memory location of a first write pointer;
writing a second video frame to a second frame buffer based on a write memory location of a second write pointer;
controlling the reading of the first video frame and the second video frame based on a read memory location of a read pointer with respect to the write memory location of the first write pointer and the second write pointer;
reading the first video frame from the first frame buffer and the second video frame from the second frame buffer based on the read memory location of the read pointer and a video frame multiplexing sequence; and
outputting a multiplexed signal to a recording device, the multiplexed signal including the first video frame and the second video frame arranged according to the video frame multiplexing sequence.

9. The method of claim 8, wherein the recording device is a multi-channel digital video recorder (“DVR”).

10. The method of claim 8, wherein the read memory location of the read pointer is maintained at least one frame behind the write memory location of the first write pointer and the second write pointer.

11. The method of claim 10, wherein the read memory location of the read pointer is two frames behind the write memory location of the first write pointer and the second write pointer.

12. The method of claim 8, wherein the multiplexed signal includes more than one common intermediate format (“CIF”), video graphics array (“VGA”), composite video (“CVBS”), red green blue (“RGB”), high-definition multimedia interface (“HDMI”), BT.1120 (“1080i”), or D1 signal.

13. The method of claim 8, further comprising serially reading each of the first video frame from the first frame buffer and the second video frame from the second frame buffer to generate the multiplexed signal.

14. The method of claim 8, wherein the plurality of video sources are unsynchronized.

15. A device for processing a plurality of digital video signals associated with a plurality of video sources, the device comprising:
a first write control module including a first write pointer;
a second write control module including a second write pointer;
a read control module including a read pointer; and
a frame rate control module configured to control the reading of a first video frame and a second video frame based on a video frame multiplexing sequence and a relationship between the read pointer, the first write pointer, and the second write pointer,
wherein the read control module is further configured to generate a multiplexed signal including the first video frame and the second video frame arranged according to the video frame multiplexing sequence.

16. The device of claim 15, further comprising one or more frame buffers configured as a circular buffer.

17. The device of claim 15, wherein the frame rate control module is further configured to prevent the read pointer from overlapping the first write pointer or the second write pointer.

18. The device of claim 15, wherein the first video frame and the second video frame are each interlaced video frames.

19. The device of claim 15, wherein the read control module is further configured to output the multiplexed signal to a recording device.

20. The device of claim 19, wherein the multiplexed signal has a resolution of at least approximately 1440×960.
